(19) United States
(12) Patent Application Publication
(10) Pub. No.: US 2013/0000027 A1
(43) Pub. Date: Jan. 3, 2013

(54) Removable, Reusable, and Flexible Urine Deflector

(76) Inventors: Deborah Marie San Luis, San Jose, CA (US); Rafael San Luis, San Jose, CA (US)

(21) Appl. No.: 13/540,155

(22) Filed: Jul. 2, 2012

Related U.S. Application Data
(60) Provisional application No. 61/503,135, filed on Jun. 30, 2011.

(51) Int. Cl. E03D 9/00; B23P 17/04

(52) U.S. Cl. 4/300.3; 29/428

(57) ABSTRACT

A flexible urine deflector reduces the inadvertent spray of urine on the surfaces of a toilet during potty training of young boys. The flexible urine deflector does not have to be removed for normal usage and is virtually unseen when the toilet seat is lowered. The flexible urine deflector is easily removable when either the toilet or the deflector needs cleaning. The flexible urine deflector may also include indicia such as trade names or cartoon characters. Deodorant or fragrance saturated materials for masking the smell of urine or other undesirable odors may also be included in some novel aspects. In other aspects, suction cups are formed as part of the flexible sheet portion and connects the flexible sheet portion to the seat and rim of a toilet. In another aspect, the deflector is made of inexpensive paraffin coated paper or similar material and is disposable.

### CROSS REFERENCE TO RELATED APPLICATION

This application is based on and hereby claims the benefit under 35 U.S.C. §119 from U.S. Provisional Application No. 61/503,135, entitled “Removable, re-usable and flexible urine splashguard used as a potty training tool for boys,” filed on Jun. 30, 2011, the subject matter of which is incorporated herein by reference.

### BACKGROUND INFORMATION

Young children often make messes in the bathroom. These messes may be worse when training children, especially boys, to use the toilet. During training and afterwards, young boys often miss or overshoot the toilet when learning to aim a stream of urine towards the bowl portion of the toilet. Urine is often sprayed on all surfaces of the toilet, the floor, and any surfaces near the toilet. If the urine remains in these locations, many undesirable effects can result: urine can stain linoleum, hardwood, and other types of flooring, causing significant damage. The odor of urine is unpleasant and the urine may also contain bacteria. These undesirable effects and others can be reduced or eliminated by frequent cleaning but repeated cleaning is onerous and made difficult by small and hard to clean surfaces of the toilet. FIG. 1 (Prior Art) is a drawing of a toilet 1. The toilet includes a tank portion 3 and a pedestal portion 2. The pedestal portion 2 includes a base 6, a pedestal surface 11, a rim 7 with rim surface 10, rim inside surface 8, and a rim diameter 9. A seat 4 with a seat lower surface 14 is connected to the pedestal surface 14 with a first hinge 12 and a second hinge 13. The first hinge 12 and second hinge 13 also connect a lid 5 to pedestal surface 11.

As mentioned above, when young children are being trained to use a toilet, urine is frequently sprayed on all surfaces of the toilet and any surfaces near the toilet. Urine may be sprayed at seat 4, lid 5, and pedestal surface 11. The urine may then run down the pedestal portion and may become deposited on the floor near base 6 of the toilet and underneath the tank portion 3 of the toilet and behind base 6. Urine may also collect on the pedestal surface 11 under seat 4 and lid 5. Urine may also splatter on the seat lower surface 14 and may also become deposited within hinges 12 and 13. The spaces between the pedestal surface 11, first and second hinge 12 and 13, and seat 4 and lid 5 can be very small. These small spaces may be very difficult and time consuming to clean. In addition, any urine that remains within these spaces can create unpleasant odors and may also cause stains on the flooring near the toilet. Many devices have been developed to eliminate the spray of urine onto the unintended areas of the toilet. For example, U.S. Pat. No. 5,625,905 issued to Woods discloses a deflector which both shields the hinge area and channels urine into the bowl section of the toilet. The apparatus disclosed by Woods however is mostly flat with a flap projecting over the hinge area of the pedestal surface and a small vertical lip extending around a portion of the rim. Any overspray or splatter in the flap area may splash over the edge and run down the base portion of the toilet. The small vertical flap is also insufficient to capture and redirect any splatter higher than the height of the lip.

U.S. Pat. No. 6,385,785 to Linden discloses a shield that attaches to the seat of a toilet and is positioned inside the bowl portion of the toilet with the shield extending vertically outward above the pedestal portion of the toilet. The device disclosed by Linden protects the hinge and seat area of the toilet from urine splatter but must be removed from the toilet before the seat can be lowered. This is unsanitary and inconvenient. A person desiring use of the toilet in the sitting position must first remove the shield and temporarily store it elsewhere before lowering the seat of the toilet. The person may not want to touch the shield if it has already been used or the shield may contaminate a countertop or other temporary storage location.

U.S. Pat. No. 6,874,171 to Erves discloses another apparatus for preventing overspray from contacting some surfaces of the toilet. The apparatus disclosed by Erves includes a frame and sheet of material attached to the frame. The frame attaches to the underside of the seat in multiple locations and to the rim of the toilet in multiple locations. This prior art device may protect the hinge and seat areas from overspray or splatter but has its own shortcomings. The frame of the device disclosed by Erves is unsightly and creates areas between the frame and the rim where urine can splatter and collect. When the seat is in the down position, the frame of the shield disclosed by Erves protrudes outward and around the rim of the toilet. These protrusions are visible and a person desiring use of the toilet in a sitting position may come in contact with the frame. Moreover, the spaces between the frame and the rim of the toilet are small and are likely difficult to clean without removing the frame from the toilet. These spaces are places where urine can collect, causing odor and uncleanliness.

U.S. Pat. No. 7,178,177 to Valencia discloses another type of toilet splash guard. The splash guard disclosed by Valencia includes a large shield device that is attached to the rim of the toilet bowl and extends vertically upwards with large side panels for directing urine splatter down the sides of the shield and into the bowl. This apparatus has similar disadvantages to that disclosed by Linden. To use the toilet in a sitting position, a person has to remove the shield and temporarily store it while using the toilet. After the person is finished using the toilet, the shield must be picked up and reattached to the rim of the toilet. Handling the urine shield multiple times is inconvenient and unsanitary.

U.S. Pat. No. 7,412,732 to Leonard discloses another splash guard device. The device disclosed by Leonard is placed between the seat and the rim of a toilet. The device is attached to both the rim and the lower surface of the seat. An opening in the device allows use of the device by a person using in the sitting position with the seat lowered. Another opening in the device allows a user to urinate through the opening while standing with the seat in the raised or vertical position. Use of this opening when the seat raised causes another problem. For small children, the opening may be positioned too high and they might not be able to direct their aim up and through the opening. For larger male adults, the hole may be too low causing the adult to use the toilet in a sitting position or to stand back from the toilet to urinate in a standing position.

U.S. Pat. No. 7,461,411 to Wolf discloses another device for preventing the contact of urine with certain surfaces of the toilet. The device disclosed by Wolf, consists of large vertical elements in combination with a child-sized seat that is placed onto the toilet. The vertical elements serve as shields while boys are urinating in the standing position and a removable seat is available for use when the child is using the toilet in a sitting position. Similar to several of the aforementioned devices, the apparatus disclosed by Wolf must be removed before an adult is able to use the toilet in the sitting position.

U.S. Pat. No. 7,921,478 to Vanini discloses another splash guard apparatus for preventing urine spray from splattering on surfaces of the toilet. The device disclosed by Vanini consists of a large shield that is attached to the rim of a toilet. When a child is using the toilet in the standing position the guard is pivoted up and a large vertical shaped shield directs urine spray down into the bowl of the toilet. When the toilet is being used by a person in a sitting position, the person must first pivot the shield to the down or lowered position. The splash guard disclosed by Vanini has the following drawbacks: the urine guard in a raised position has to be physically moved by a person desiring use of the toilet in a sitting position. This is unsanitary and cumbersome. In addition, the edge of the shield intersects or crosses the rim of the toilet and urine hitting the shield can run down the shield and over the outside rim of the toilet. The shield is also visible even when not in use which may be aesthetically undesirable. Finally, urine can splatter into the small spaces between the toilet and the suction cups of the shield causing a mess and unpleasant odors.

U.S. Pat. Application Publication No. US 2009/0172871 to Bird discloses a rigid device that is attached to a seat of a toilet and hangs downward from the toilet seat. When the seat is in the raised or vertical position, the shield hangs down in front of the hinge areas. When the seat is lowered, the device is lowered into the bowl section of the toilet. This device also has undesirable aspects. The device is constructed of rigid plastic or other material and urine can richochet off of this rigid structure and onto the surfaces of the toilet. In addition, the device is visible when the seat is in the raised or lowered position which is not visually appealing. Finally, when the seat is in the lowered position, the shield may come into contact with the water and human waste that may be present within the bowl of the toilet. This may create unsanitary effects and become a source of unpleasant odors.

U.S. Pat. Application Publication No. US 2009/0211007 to Partridge discloses another type of shield that is affixed to the underside of the seat of a toilet in a manner similar to the apparatus disclosed by Bird. In addition to the undesirable aspects of the device disclosed by Bird, Partridge's apparatus also includes a wire frame. Adding wire to the shield increases cost and provides rigidity that may cause urine to splash off of the shield and onto the toilet.

A low cost and effective urine shield or deflector is desired that does not require removal before use of the toilet by a person in a sitting position. Another desirable aspect is for the shield is to remain out of sight when the seat is in a lowered position.

### SUMMARY

The present invention includes a flexible urine deflector that reduces the inadvertent spray of urine during potty training of young male children and subsequent uses. The flexible urine deflector does not have to be removed for adult or normal use outside of potty training and remains virtually unseen when the toilet seat is lowered. The flexible urine deflector is also easily removable when either the toilet or the urine deflector needs cleaning. The flexible urine deflector includes a flexible sheet portion, a first row of attachment structures and a second row of attachment structures. The first row of attachment structures attaches a sheet portion of the deflector to the seat of a toilet and the second row of attachment structures connects the sheet portion to the rim of a toilet. The sheet portion is made of vinyl or other flexible material and the attachment structures can be hook and loop, suction cups or any other suitable structure for attaching the flexible sheet portion to a toilet. In another novel aspect the flexible urine deflector also includes indicia such as the deflector's trade name, cartoon characters or target designs. The indicia may be printed on the back of a transparent flexible sheet portion or in between layers of a multilayer flexible sheet. In yet another novel aspect, the flexible urine deflector includes a deodorant or fragrance impregnated material for masking the smell of urine or other undesirable odors. In one novel aspect, suction cups are formed within or are disposed on the flexible sheet portion. The suction cups connect the flexible sheet portion to both the seat and the rim of a toilet. In another novel aspect, the flexible urine deflector includes multiple layers of disposable sheet portions that can be discarded or flushed after they become soiled. In another aspect, the flexible urine deflector is made of inexpensive paraffin coated paper or similar material and is disposable after a few uses. A novel method in accordance with one embodiment is also disclosed that includes the steps of removing both the flexible urine deflector and the instructions for attachment from a package and attaching the urine deflector to the seat and the rim of a toilet. In a final novel method, the additional steps of removing the urine deflector from the toilet, cleaning the urine deflector and reattaching the urine deflector to the toilet are disclosed.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) is a drawing of a toilet.

FIG. 2 is a drawing of a novel flexible urine deflector.

FIG. 3 is a cross-sectional drawing of the novel flexible urine deflector of FIG. 2.

FIG. 4 is a drawing of a flexible urine deflector attached to a toilet.

FIG. 5 is a top-down drawing of a flexible urine deflector attached to a toilet with the seat of the toilet in a lowered position.

FIG. 6 is another drawing of a flexible urine deflector attached to a toilet with the seat of the toilet in a raised position.

FIG. 7 is a drawing of a flexible urine deflector with indicia.

FIG. 8 is a cross-sectional drawing of the flexible urine deflector with indicia of FIG. 7.

FIG. 9 is a drawing of a novel flexible urine deflector that includes two flexible sheet layers and indicia.

FIG. 10 is a cross-sectional drawing of the urine deflector shield of FIG. 9.

FIG. 11 is drawing of a flexible urine defector with suction voids and indicia.

FIG. 12 is a cross-sectional drawing of the urine deflector shield with suction voids and indicia of FIG. 11.

FIG. 13 is a drawing of a flexible urine deflector with suction cup attachment structures in accordance with another novel aspect.

FIG. 14 is a cross -sectional drawing of the flexible urine deflector with suction cup attachment structures of FIG. 13.

FIG. 15 is a drawing of a flexible urine deflector with three layers of flexible sheets in accordance with yet another novel aspect.

FIG. 16 is a cross-sectional drawing of the flexible urine deflector with three layers of flexible sheets of FIG. 15.

FIG. 17 is a flowchart of a novel method of attaching a flexible urine deflector to a toilet.

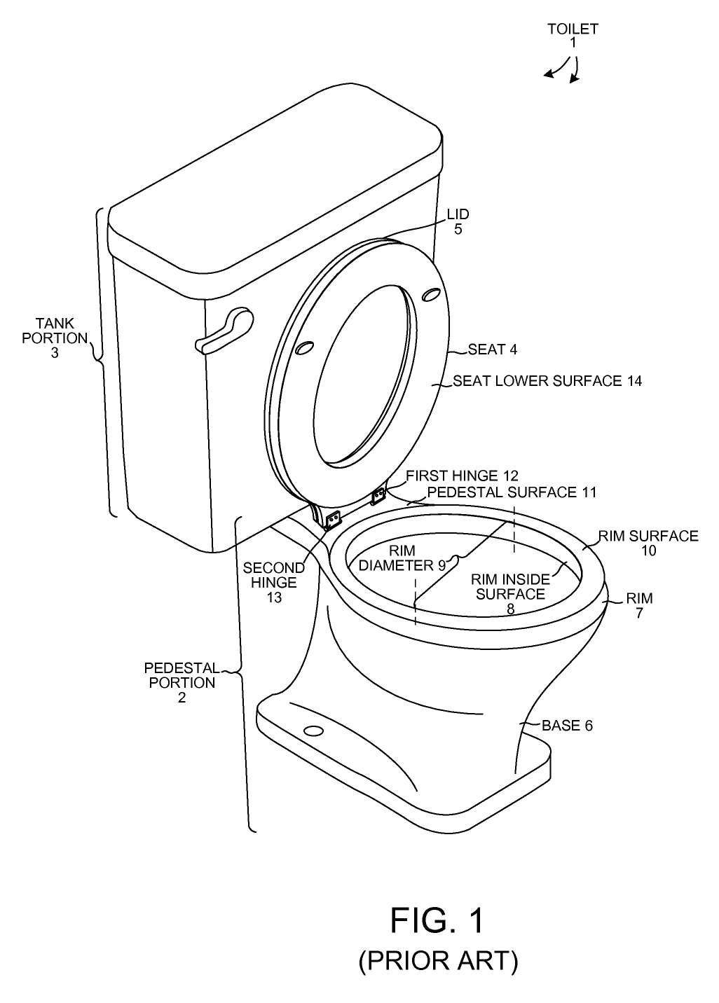

### DETAILED DESCRIPTION

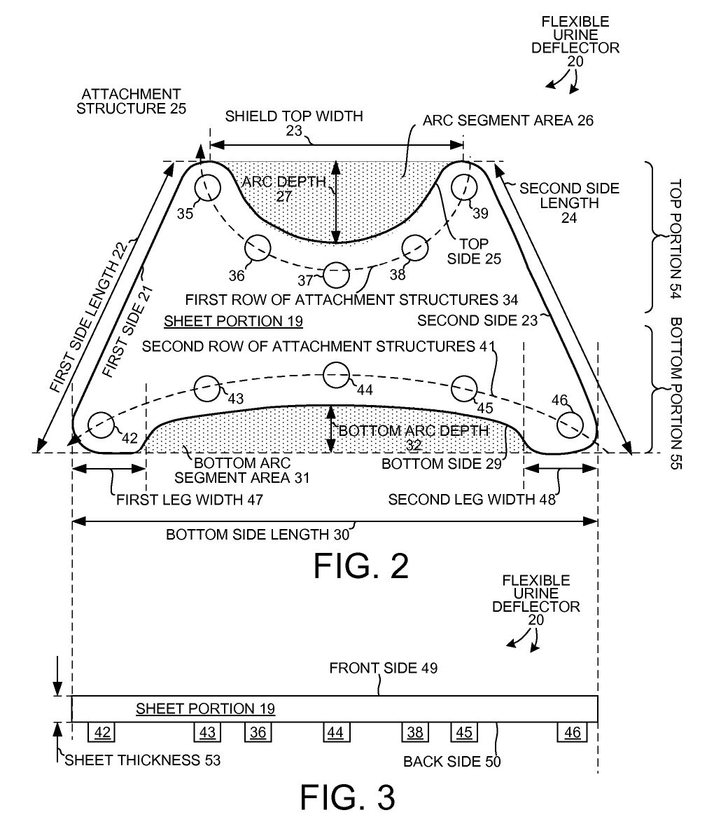

FIG. 2 is a drawing of a flexible urine deflector 20 that includes a sheet portion 19, a first side 21, a second side 23, a top side 25, a bottom side 29, a first row of attachment structures, 34, a second row of attachment structures 41. The sheet portion 19 is flexible and may be made of any of the following types of materials: a gum elastic material, a polyurethane material, poly vinyl chloride (PVC) material, a vinyl material, a polyethylene material, a polymer material, a silicone material, a nylon material, a flexible silicone composition, a polyamide material, an acrylic material, a polyesther block amide material or any other suitable material.

The first side 21 of sheet portion 19 is substantially linear and is opposite but not parallel to second side 23. The first side 21 and the second side 23 may connect to bottom side 29 at rounded intersections. The bottom side is opposite top side 25. In one novel aspect top side 25 connects to first side 21 and second side 23 and may also connect at rounded intersections. The top side is arcuate and defines an arc segment area 26 and has an arc depth 27 that is in the range of two and one-half inches to four inches. The arcuate top side 25 also has an arc length and the arc length is in the range of eight and one-half inches to twelve and one-half inches. The first side 21 has a first side length 22 and first side length 22 is in the range of eight and one-half inches to twelve and one-half inches. Second side 23 has a second side length 24 and second side length 24 is in the range of eight and one-half inches to twelve and one-half inches. The bottom side 29 has a bottom side length 30 and the bottom side length 30 is in the range of sixteen inches to twenty and one-half inches. The first row of attachment structures 34 includes a plurality of attachment structures 35-39 disposed in a curved row and the second row of attachment structures 41 includes a plurality of attachment structures 42-46 disposed in a curved row. The attachment structures are suitable for attaching sheet portion 19 to both a seat of a toilet and a rim of a toilet and may include any of the following attachment structures: hook and loop fasteners, double sided tape, suction cups, suction voids, plastic or metal snaps or any other suitable type of attachment structure. In some embodiments, either the first row of attachment structures, or the second row of attachment structures, or both is not curved. In another novel aspect, the attachment structures may be one-half inch to one and one-half inches in diameter. In another novel aspect, the bottom side 29 is arcuate and defines a bottom arc segment area 31 and has a bottom arc depth 32 that may be in the range of one-half inch to two and one-half inches. In this embodiment the bottom side 29 also has an arc length and the arc length is in the range of twelve inches to sixteen inches. A first leg of sheet portion 19 with a first leg width 47 is disposed to the left of the bottom arc segment area 31 and a second leg of sheet portion 19 with a second leg width 48 is disposed to the right of bottom arc segment area 31.

FIG. 3 shows a cross-sectional view of the flexible urine deflector 20 of FIG. 2. In this FIG. 3, flexible urine deflector 20 includes a sheet portion 19 with a front side 49 and a back side 50, and attachment tructures 36, 38, and 42-46 are shown disposed on back side 50 of sheet portion 19. In one novel aspect the flexible urine deflector has a sheet thickness 53 and the sheet thickness may be in the range of 0.004 inches to 0.16 inches in thickness. The sheet portion may be a one-piece vinyl or similar extrusion having a Shore A durometer hardness of less than 100 and a stiffness of less than 50 MPa as measured with a Tinius Olsen stiffness tester.

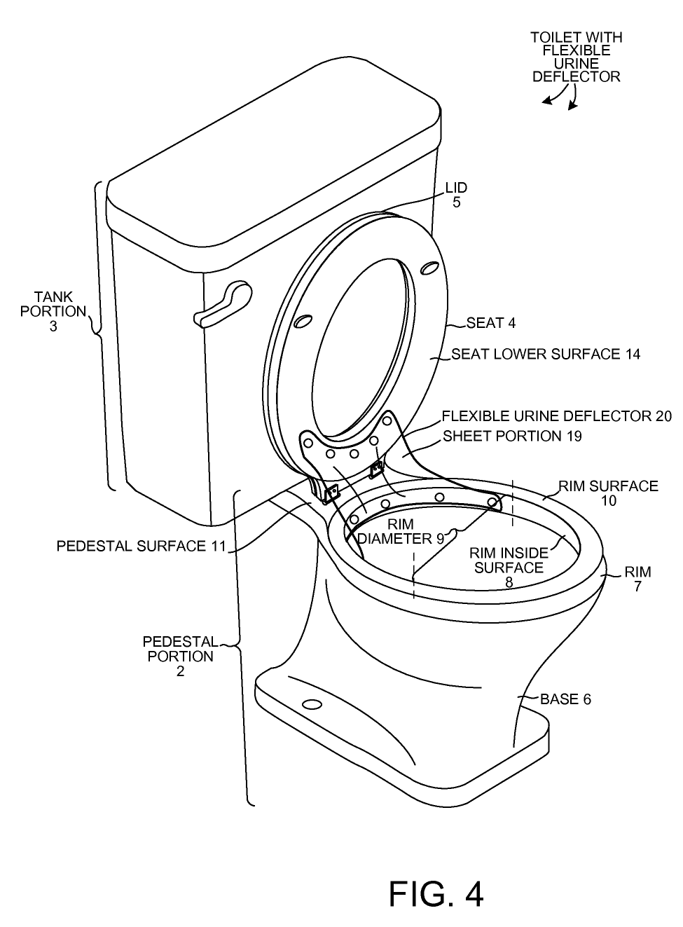

FIG. 4 shows a flexible urine deflector 20 attached to a toilet. In this FIG. 4, the flexible urine deflector is attached to the seat lower surface 14 of seat 4 and rim inside surface 8 of rim 7. The first row of attachment structures 34 are disposed between the flexible sheet portion 19 and the seat lower surface 14 of seat 4 and the second row of attachment structures 41 are shown disposed between sheet portion 19 and rim inside surface 8 of rim 7 of the toilet. The attachment structures may be hook and loop fasteners, double sided tape, suction cups, suction voids, metal snaps or any other suitable type of attachment structure. The attachment structures provide for easy removal of the flexible urine deflector from a toilet to allow for cleaning of the toilet or the flexible urine deflector. The flexible urine deflector may be cleaned by immersing it in soapy water or it may be washed in a washing machine and then the deflector can be reattached to the toilet. In one novel embodiment, the attachment structures are suction cups and the flexible urine deflector 20 is attached to seat lower surface 14 of seat 4 by positioning the top side 25 of flexible urine deflector 20 on seat lower surface 14 and exerting force on each suction cup in the first row of attachment structures to create a vacuum that secures the sheet portion 19 to the seat lower surface 14. The bottom side 29 of sheet portion 19 is then positioned over the rim inside surface 8 of rim 7 with the attachment structures of the second row of attachment structures 41 disposed in between the sheet portion 19 and the rim inside surface 8 of rim 7 in an area below seat 4. Exerting force on each suction cup in the second row of attachment structures 41 creates a vacuum that secures sheet portion 19 to the rim inside surface 8 of rim 7. In this novel embodiment, flexible urine deflector 20 is not stretched tight but is loosely coupled between seat lower surface 14 and rim inside surface 8 so that a stream of urine directed at the shield is “cushioned” by some slack in the flexible urine deflector.

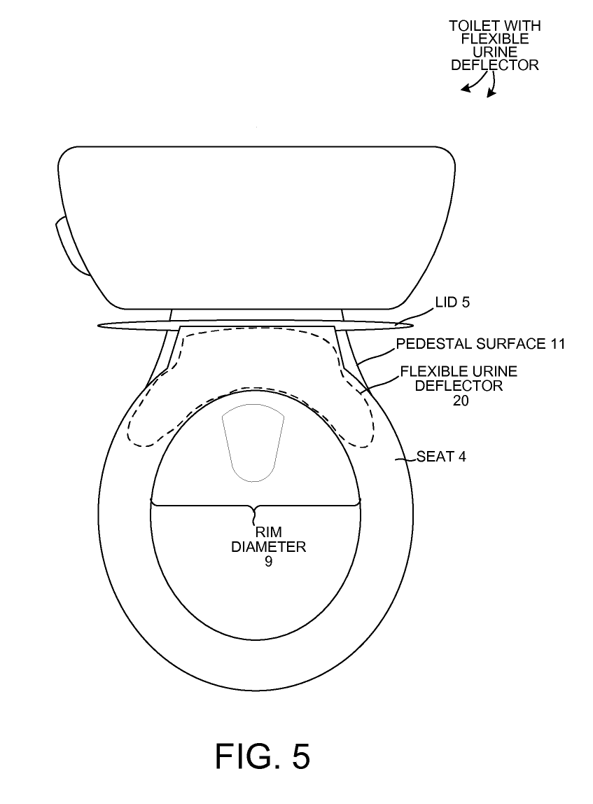

FIG. 5 shows another novel aspect of a flexible urine deflector 20 attached to a toilet. In FIG. 5, the seat 4 of the toilet is in a lowered position. In this position, the toilet can be utilized by a person while seated. When seat 4 is in the lowered position, flexible urine deflector 20 is disposed between seat 4, pedestal surface 11, and rim surface 10. In this novel embodiment, the flexible urine deflector 20 does not extend beyond the seat lower surface of seat 4. Because flexible urine deflector 20 folds under the seat 4 as seat 4 is lowered from a raised position to a lowered position, it is not necessary for a person to remove the flexible urine deflector from the toilet in order to utilize the toilet while in a seating position.

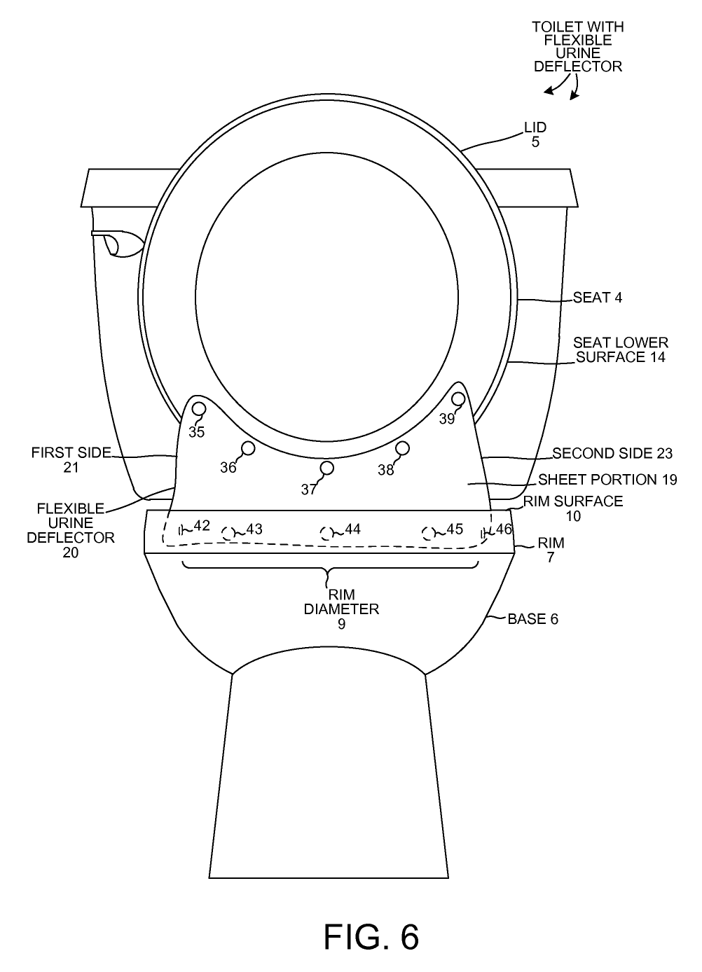

FIG. 6 is a drawing of a flexible urine deflector 20 attached to a toilet. A first side 21 and a second side 23 of flexible urine deflector 20 are shown in this FIG. 6. A base 6 of the toilet is also shown with a rim 7, rim surface 10, a seat 4 with seat lower surface 14 and a lid 5. Rim 7 also has an inside rim diameter 9. Attachment structures 35-39 of first row of attachment structures 34 are disposed between the sheet portion 19 and the seat lower surface 14 of seat 4 and attachment structures 42-46 of second row of attachment structures 41 are disposed between sheet portion 19 and the rim inside surface 8 of rim 7. The first side 21 of flexible sheet portion 19 is aligned with the left edge of inside rim diameter 9 and the second side 23 of sheet portion 19 is aligned with the right edge of inside rim diameter 9. In this novel embodiment, any urine making contact with flexible urine deflector 20 will be deflected into the toilet within inside rim diameter 9.

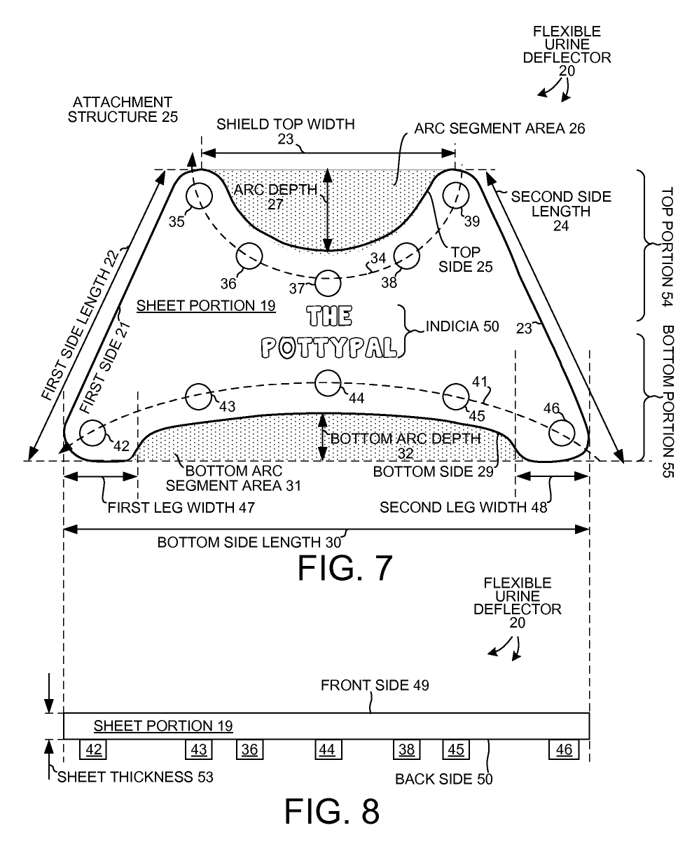

FIG. 7 is a drawing of a flexible urine deflector 20 in one novel aspect. Flexible urine detector 20 has a flexible sheet portion 19, a first curved row of attachment structures 34 with attachment structures 35-39 and a second curved row of attachment structures 41 with attachment structures 42-46. Indicia 50 is also shown disposed on sheet portion 19 between top side 25 and bottom side 29. In this embodiment shown in FIG. 7 the indicia 50 is the potential trade name, “The Pottypal” of flexible urine deflector 20. In other embodiments the sheet portion 19 may include other indicia such as target designs, cartoon characters, or other indicia. In one novel embodiment, indicia 50 are printed on the back side 50 (shown in FIG. 8) of sheet portion 19 and sheet portion 19 is transparent. In this embodiment, the indicia are seen through the transparent sheet portion but urine is not able to stain or soak into the ink or material of indicia 50.

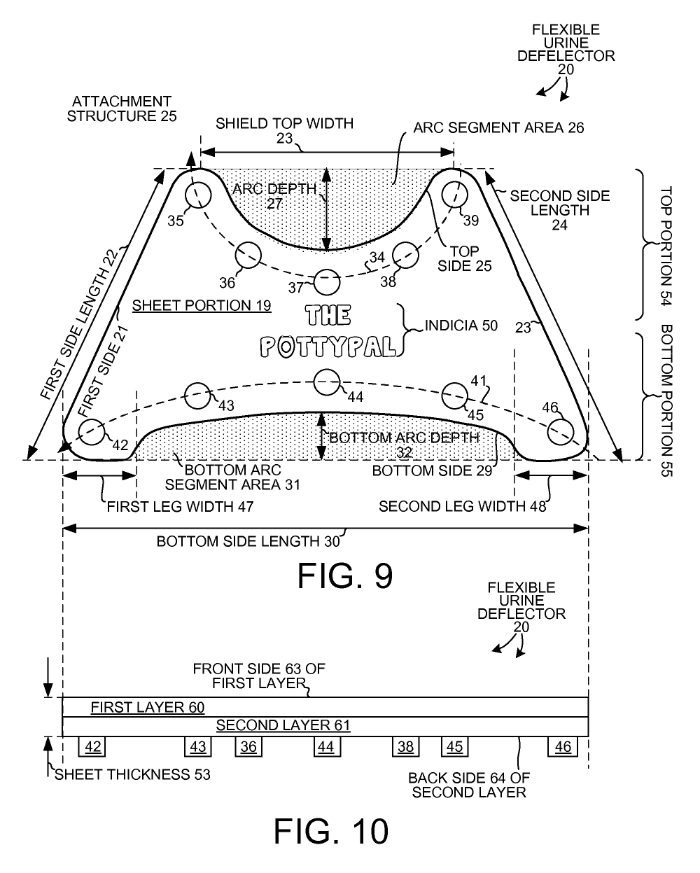

FIG. 9 is a drawing of a flexible urine deflector 20 in another novel aspect. Flexible urine detector 20 has a flexible sheet portion 19, a first curved row of attachment structures 34 with attachment structures 35-39 and a second curved row of attachment structures 41 with attachment structures 42-46. Indicia 50 are also shown disposed on sheet portion 19 between top side 25 and bottom side 29. FIG. 10 is a cross-sectional drawing of a flexible urine deflector corresponding to the flexible urine deflector 20 of FIG. 9 and shows a first layer 60 and a second layer 61 disposed between a front side 63 of the first layer and a back side 64 of the second layer. FIG. 10 also shows attachment structures 36, 38 and 42-46 disposed on the back side 64 of the second layer. In this embodiment shown in FIG. 10 the indicia 50 is disposed between first layer 60 and second layer 61. First layer 60 is transparent and indicia 50 are seen at front side 63 of the first layer. Second layer 61 may be attached to first layer 60 by adhesive or any other suitable method. In this novel embodiment, indicia 50 are isolated from any urine that may be splashed onto the back of the flexible urine deflector. This prevents urine from staining or soaking into the indicia 50. In other embodiments first layer 60 or second layer 61 may be a deodorant or fragrance impregnated layer for masking the smell of urine or other undesirable odors.

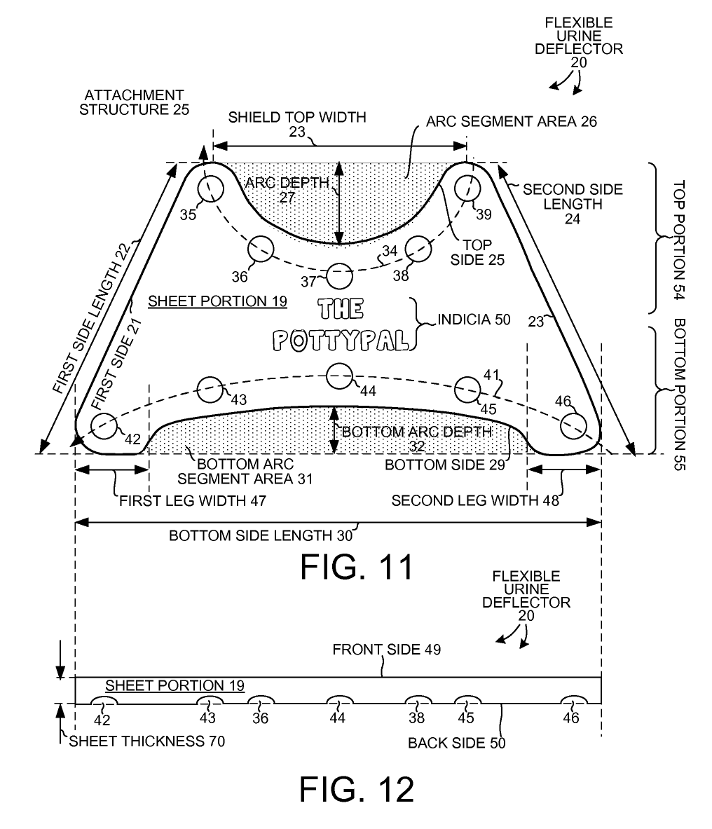

FIG. 11 is a drawing of a flexible urine deflector 20 in accordance with another novel aspect. Flexible urine detector 20 has a flexible sheet portion 19, a first curved row of attachment structures 34 with attachment structures 35-39 and a second curved row of attachment structures 41 with attachment structures 42-46. Indicia 50 are also shown disposed on sheet portion 19 between top side 25 and bottom side 29. In this FIG. 11, attachment structures 35-39 of first row of attachment structures 34 and attachment structures 42-46 of second row of attachment structures 41 are suction void structures. FIG. 12 is a cross-sectional drawing of the flexible urine deflector of FIG. 11 and shows the cross-section taken through suction voids 36, 38, and 42-46. Suction voids are circular voids formed within the back side 50 of sheet portion 19. The voids can be created by extrusion processes or extrusion processes combined with thermoforming or any suitable process for patterning flexible vinyl sheets or similar materials. The suction voids are similar to suction cups and create a vacuum between the back side 50 of the sheet portion 19 and the surfaces of a toilet when force is exerted on a suction void attachment structure from the front side 49 of sheet portion 19.

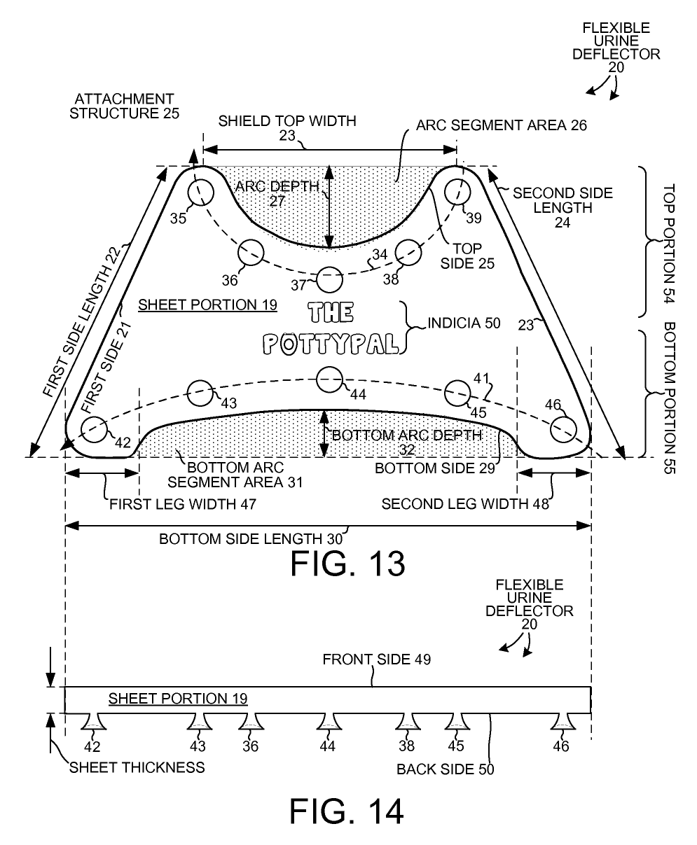

FIG. 13 is a drawing of a flexible urine deflector 20 in accordance with yet another novel aspect. Flexible urine detector 20 has a flexible sheet portion 19, a first curved row of attachment structures 34 with attachment structures 35-39 and a second curved row of attachment structures 41 with attachment structures 42-46. Indicia 50 are also shown disposed on sheet portion 19 between top side 25 and bottom side 29. In this FIG. 11, attachment structures 35-39 of first row of attachment structures 34 and attachment structures 42-46 of second row of attachment structures 41 are suction cups. FIG. 14 is a cross-sectional drawing of the flexible urine deflector of FIG. 13 and shows the cross-section taken through suction cups 36, 38, and 42-46. In one embodiment, the suction cups are formed on back side 50 of sheet portion 19 during the fabrication of sheet portion 19. In an alternative embodiment, the suction cup attachment structures are attached to sheet portion 19 by adhesive or other suitable method. The suction cups create a vacuum and connect the sheet portion 19 to the surfaces of a toilet when force is exerted on the front side 49 of sheet portion 19 above a suction cup attachment structure.

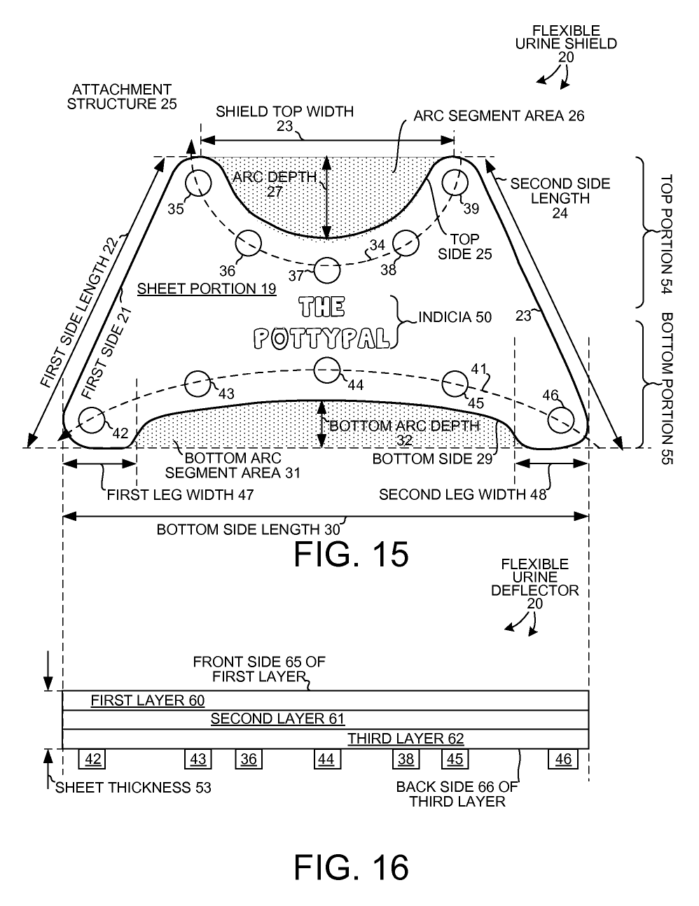

FIG. 15 is a drawing of a flexible urine deflector 20 in another novel aspect. Flexible urine detector 20 has a flexible sheet portion 19, a first curved row of attachment structures 34 with attachment structures 35-39 and a second curved row of attachment structures 41 with attachment structures 42-46. Indicia 50 are also shown disposed on sheet portion 19 between top side 25 and bottom side 29. FIG. 16 is a cross-sectional drawing of the flexible urine deflector 20 of FIG. 15 and shows a first layer 60, a second layer 61, and a third layer 62 disposed between a front side 65 of a first layer and a back side 66 of the third layer 62. FIG. 16 also shows attachment structures 36, 38 and 42 - 46 disposed on back side 66 of third layer 62. In this embodiment shown in FIG. 16 first layer 60 is statically or similarly loosely coupled to second layer 61 and second layer 61 is statically otherwise loosely coupled to third layer 62. This embodiment of FIG. 16 allows for the first and second layers to be removed and discarded one at a time after they are soiled. In another embodiment, the flexible urine deflector has more than three layers of disposable sheet portions. In yet another novel aspect, the sheet portion 19 of flexible urine deflector 20 is made of inexpensive material such as paraffin coated paper and can be attached to the toilet with adhesive and simply discarded after several uses. This novel aspect of a flexible urine deflector may also be flushed down the toilet after several uses.

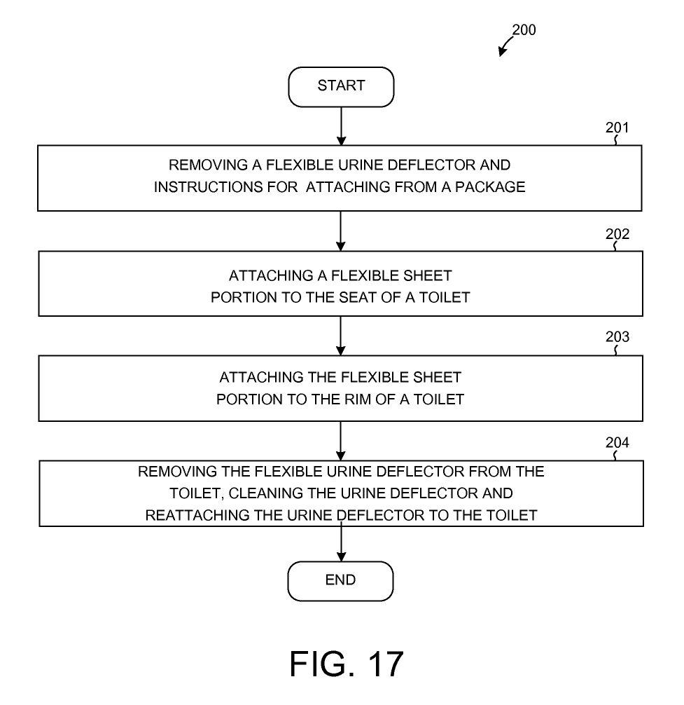

FIG. 17 is a simplified flowchart diagram 200 of a novel method in accordance with one embodiment. In the initial step 201, a flexible urine deflector and attachment instructions are removed from a package containing the flexible urine deflector and instructions for attaching the flexible urine deflector to a toilet.

Next, in step 202, a flexible sheet portion of the flexible urine deflector is attached to the seat of a toilet.

Next, in step 203, the flexible sheet portion of the flexible urine deflector is attached to the rim of a toilet bowl.

In another novel method a subsequent step 204 exists wherein step 204 includes removing the flexible sheet portion of the flexible urine deflector, cleaning the flexible urine deflector and reattaching the flexible urine deflector to the toilet. In yet another novel method, the method includes a subsequent step of using the toilet.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. An apparatus comprising:
a flexible sheet portion having a first side, a second side, a bottom side and a top side, wherein the top side is arcuate and defines an arc segment area and has an arc depth wherein the arc depth is in the range of two and one-half inches to four inches, and wherein the top side has an arc length in the range of eight and one-half inches to twelve and one-half inches and wherein the first and second sides are substantially linear and are opposite but not parallel to one another and each of said first and second sides has a length in a range of eight and one-half inches to twelve and one-half inches, and wherein the bottom side has a length and the length is in the range of sixteen inches to twenty and one-half inches; and wherein the top side and the bottom side are opposite each other;
a first row of attachment structures that extends in a curve along the top side;
a second row of attachment structures that extends in a curve along the bottom side;
wherein the attachment structures of the first and second row of attachment structures are taken from the group consisting of: hook and loop fasteners, double sided tape, suction cups, suction voids, plastic and metal snap fasteners.

2. The apparatus of claim 1, wherein the distance from any point on the top side to any point on the bottom side is less than twenty inches.

3. The apparatus of claim 1, wherein said apparatus also includes a package containing instructions how to attach said sheet portion to a toilet.

4. The apparatus of claim 1, wherein said sheet portion has a thickness and the thickness is in the range of 0.004 inches to 0.16 inches.

5. The apparatus of claim 1, wherein the bottom side is arcuate and defines a bottom arc segment area and has a bottom arc depth wherein the bottom arc depth is in the range of one-half inch to two and one-half inches, and wherein the bottom side has an arc length in the range of twelve inches to sixteen inches.

6. The apparatus of claim 1, wherein the sheet portion further comprises indicia.

7. The apparatus of claim 1 further comprising a toilet seat; wherein the attachment structures of the first row attach the sheet portion to the toilet seat; and
a rim of a toilet bowl wherein the attachment structures of the second row attach the sheet portion to the rim of the toilet bowl.

8. The apparatus of claim 1, wherein the sheet portion comprises a one-piece vinyl extrusion having a Shore A durometer hardness of less than 100 and a stiffness of less than 50 MPa as measured with a Tinius Olsen stiffness tester.

9. The apparatus of claim 1, wherein said sheet portion comprises a material taken from the group consisting of: a gum elastic material, a polyurethane material, a poly vinyl chloride (PVC) material, a vinyl material, a polyethylene material, a polymer material, a silicone material, a nylon material, a flexible silicone composition, a polyamide material, an acrylic material, and a polyesther block amide material.

10. A method comprising:
attaching a first row of attachment structures of a flexible sheet portion to a toilet seat; and
attaching a second row of attachment structures of the flexible sheet portion to an inside rim of a toilet bowl wherein the flexible sheet portion does not include an orifice.

11. The method of claim 9, wherein the flexible sheet portion has a thickness and the thickness is within the range of 0.004 inches to 0.16 inches.

12. The method of claim 9, wherein the attachment structures of the first and second row of attachment structures are suction cups disposed upon the flexible sheet portion.

13. The method of claim 9, wherein the flexible sheet portion also comprises indicia.

14. The method of claim 9, wherein said sheet member comprises a material taken from the group consisting of: a gum elastic material, a polyurethane material, poly vinyl chloride (PVC) material, a vinyl material, a polyethylene material, a polymer material, a silicone material, a nylon material, a flexible silicone composition, a polyamide material, an acrylic material, and a polyesther block amide material.

15. An apparatus comprising:
a flexible sheet portion having a first side, a second side, a bottom side and a top side, wherein the top side is arcuate and defines an arc segment area and has an arc depth wherein the arc depth is in the range of two and one-half inches to four inches, and wherein the top side has an arc length in the range of eight and one-half inches to twelve and one-half inches and wherein the first and second sides are substantially linear and are opposite but not parallel to one another and each of said first and second sides has a length in a range of eight and one-half inches to twelve and one-half inches, and wherein the bottom side has a length and the length is in the range of sixteen inches to twenty and one-half inches; and wherein the top side and the bottom side are opposite each other; and
means for attaching the sheet portion to a toilet.

16. The apparatus of claim 15, wherein the means for attaching includes a first row of attachment structures and a second row of attachment structures.

17. The apparatus of claim 16, wherein the attachment structures of the first and second rows of attachment structures includes suction cups.

18. The apparatus of claim 15, wherein the sheet portion comprises a material taken from the group consisting of: a gum elastic material, a polyurethane material, a poly vinyl chloride (PVC) material, a vinyl material, a polyethylene material, a polymer material, a silicone material, a nylon material, a flexible silicone composition, a polyamide material, an acrylic material, and a polyesther block amide material.

19. The apparatus of claim 15, wherein the bottom side is arcuate and defines a bottom arc segment area and has a bottom arc depth wherein the bottom arc depth is in the range of one-half inch to two and one-half inches, and wherein the bottom side has an arc length in the range of twelve inches to sixteen inches.

20. The apparatus of claim 15, wherein said apparatus also includes a package containing instructions how to attach said sheet portion to a toilet.
